(19) United States
(12) Patent Application Publication
(10) Pub. No.: US 2005/0277538 A1
(43) Pub. Date: Dec. 15, 2005

(54) Automated device for homogenization and resuspension of substances, disintegration of cells, disruption of tissues and centrifugation of these media

(76) Inventors: Michael Sherman, Newton, MA (US); Yury Sherman, Roslindale, MA (US)

Correspondence Address: Yury Sherman, 511 Beech Street, Roslindale, MA, 02131, US

(21) Appl. No.: 10/866,050

(22) Filed: Jun. 14, 2004

(51) Int. Cl. B04B 5/02

(52) U.S. Cl. 494/16

(57) ABSTRACT

A device for biological and medical tests wherein tested media placed in test tube is subjected to mixing, or homogenization, or resuspention, or disintegration, or disruption, and further centrifugation of these media, including: a rotor having a replaceable closure, driving means having substantially vertical shaft, striking means capable to engage or disengage test tubes and means for moving the rotor up and down, along a the shaft that provides engagement or disengagement of said striking means with said tubes.

### TECHNICAL FIELD

The present invention relates to homogenization of substances and disruption/disintegration of cells and tissues, and centrifugation of these media and, more particularly, to a novel automated device for homogenization and resuspension of substances, disruption of living cells, disintegration of tissues contained in test tubes, and centrifugation of these and similar media.

### BACKGROUND ART

Disruption of various types of cells and tissues, mixing solutions and centrifugation are very widespread procedures both in biomedical researches and clinics. Often these procedures are performed in multiple test tubes. The test tubes filled with various solutions, cell suspensions or pieces of tissues, are exposed to homogenization, or mixing, or resuspension, or disruption, or disintegration followed by centrifugation. Accordingly tubes having tested media inside should be taken from a rack, manually placed in a device that makes homogeneous solution of the media, and then manually placed in a centrifuge rotor. These procedures are time-consuming and tedious, and often lead to mistakes in placing of tubes in a proper order, eventually leading to mistakes in experimental results. An automated device which combines these functions to reduce manual operations and inevitable errors would be very desirable.

However, existing technologies of mixing/disintegration and centrifugation are the main obstacle for creation of such a device.

The nature of the processes of homogenization/resuspension and disintegration/disruption of substances are quite opposite to the centrifugation process. The first two are used to make homogenized media, whereas the centrifugation needs to separate the homogenized media into liquid and solid components. This difference determines differences in mechanical principals of the existing devices: homogenization/resuspension is achieved by vibrating, shaking and vortexing of media in test tubes whereas centrifugation—by high-speed rotation of tubes along an outside axis. As a result, even though these processes are usually performed subsequently, they are incompatible.

The development of a device that can perform both processes became possible after a new striking technology for homogenization/resuspension of substances and disintegration/disruption of tissues and cells was invented (U.S. Pat. No. 5,769,538 “Mixer having means for periodically mechanically striking liquid-containing tubes to induce motion of the tubes”).

The technology is based on striking of test tubes with media placed inside. The tubes are subjected to thousands (5,000-8,000 or more) of hits per minute that induce vigorous turbulent motion of the media and a very effective homogenization/resuspension of substances or disintegration/disruption of cells and tissues in presence of glass beads. As a striking means it is used multiple of extensions engaged the tubes' walls when the striking means is rotated.

The described technology, as well as centrifugation technology, both based on rotation of the tubes or means for their processing about outside axis. These technologies are compatible that is exploited in the present invention.

Accordingly, a principal object of the present invention is to provide an automated device for mixing and homogenization substances or resuspension pellets or disintegration of living cells, or disruption of tissues placed in test tubes, and subsequent centrifugation these media. Additional advantage of the device is ability to remove the rotor from the device, and place it on a separate stand to be used as a rack for manipulations with the tubes.

### DISCLOSURE OF INVENTION

The present invention achieves the above objectives, among others, by providing, in a preferred embodiment, a device for biological and medical tests wherein tested media placed in test tube is subjected to following processes performed in two stages: the first stage is mixing, or homogenization, or resuspention, or disintegration, or disruption, and the second stage is centrifugation, comprising: a housing, a replaceable rotor for said tubes having a closure, a driving means for rotation of said rotor about the axis located outside said tubes, capable to rotate said rotor clockwise or counterclockwise and to move the rotor along the shaft, and a striking means, capable to engage walls of said tubes at the first stage and disengage the walls at the second stage of processing of tested tubes.

### BRIEF DESCRIPTION OF DRAWING

Understanding of the present invention and the various aspects thereof will be facilitated by reference to the accompanying drawing figures, provided for purposes of illustration only and not intended to define the scope of the invention, on which:

FIG. 1 is a cross sectional view of the device when test tubes are subjected to striking.

FIG. 2A is a fragment showing test tubes in their lowest position when they are engaged with striking means and in their upper position (dotted line) when they are disengaged with striking means, and B is a side view along V (W is a direction of the test tubes rotation).

FIG. 3 is a fragment showing means for moving the rotor up and down along the shaft.

### DETAILED DESCRIPTION OF THE PREFERRED EMBODIMENTS

The invention is related to automated devices for biological and medical tests wherein tested media in test tube is subjected to mixing, or homogenization, or resuspention, or disintegration, or disruption, or centrifugation.

The main novelty in this device is striking of test tubes that induce vigorous motion of the media inside the tubes, and following centrifugation of the media in the tubes.

The description of the invention is made with an example of a device for test tubes of 1, 5-2 ml volume, providing consequently homogenization of substances in test tubes and centrifugation of the homogenized media.

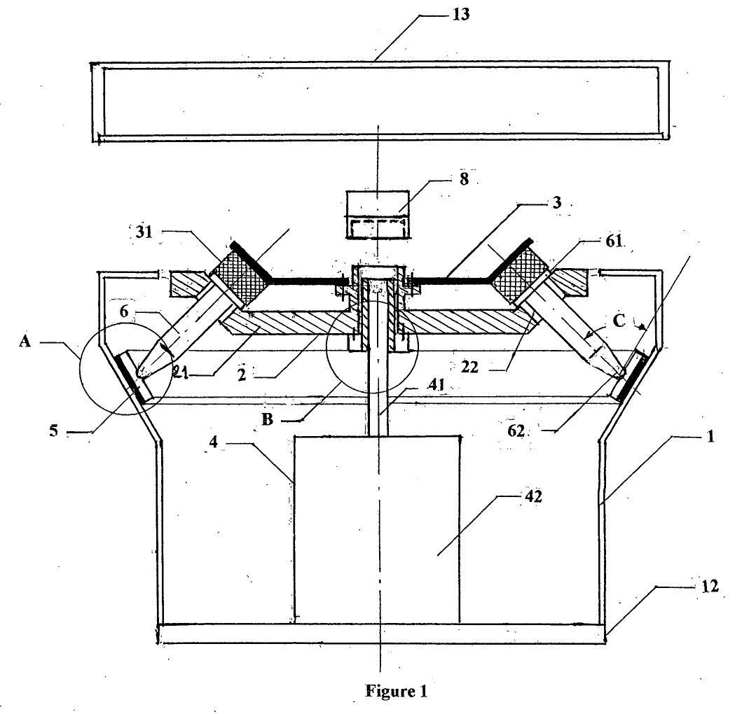

Referring to the drawings in detail, in FIGS. 1-3 a device for homogenization and centrifugation of substances placed in test tubes is shown in the preferred embodiment. The device includes: housing 1 having base 12 and lid 13, rotor 2 having replacable closure 3, driving means 4 that is an electric motor having substantially vertical shaft 41, striking means 5 capable to engage or disengage test tubes 6 and means 7 for moving rotor 2 up and down along shaft 41.

Rotor 2 is a support for a number of tubes 6. The main part of the rotor is disk 21 having holes 22 the tubes pass through. The axis of the holes is tilted about shaft 41 that provides tilted position of tubes 6. The tubes are supported by rotor 2 due to the diameter of flange 61 of the tubes is bigger than the diameter of holes 22 (FIG. 1). The gap between hole 22 and tube 6 placed inside the hole provides limited angular movement of the tube when outer forces are applied.

Rotor 2 includes means 7 for moving the rotor up and down along shaft 41 (Fig.3). Means 7 includes sleeve 71 and bush 72 embracing the sleeve. Sleeve 71 is attached to shaft 41, such that when the shaft is rotated, sleeve 71 receives the same rotation. The bush is moveable along sleeve 71. There is extension 73 extended from a wall of the bush, directed toward the sleeve. At the outer surface of the sleeve there is at least one spiral groove 74. The groove is capable to accommodate extension 73 of the bush and provides sliding contact with the extension, such that when the sleeve is rotated, the bush moves up or down along the sleeve. The distance (approx. ¼”) between the upper and the lower ends of said groove determines extreme upper and lower positions of bush 73 along sleeve 71 when the sleeve is rotated. As a version, sleeve 71 can be easy removable from shaft 41 and reinstalled.

Rotor 2 is supported by and coupled with bush 72. When the bush is rotated about shaft 41, the rotor receives the same rotation and when the bush moves up or down along the sleeve, the rotor also moves up and down. As is clear, the same motions receive tubes 6 inside the rotor. The vertical motion of the tubes places them in a position providing engagement or disengagement of the tubes with striking means 5. As a version, rotor 2 can be integrated with bush 72.

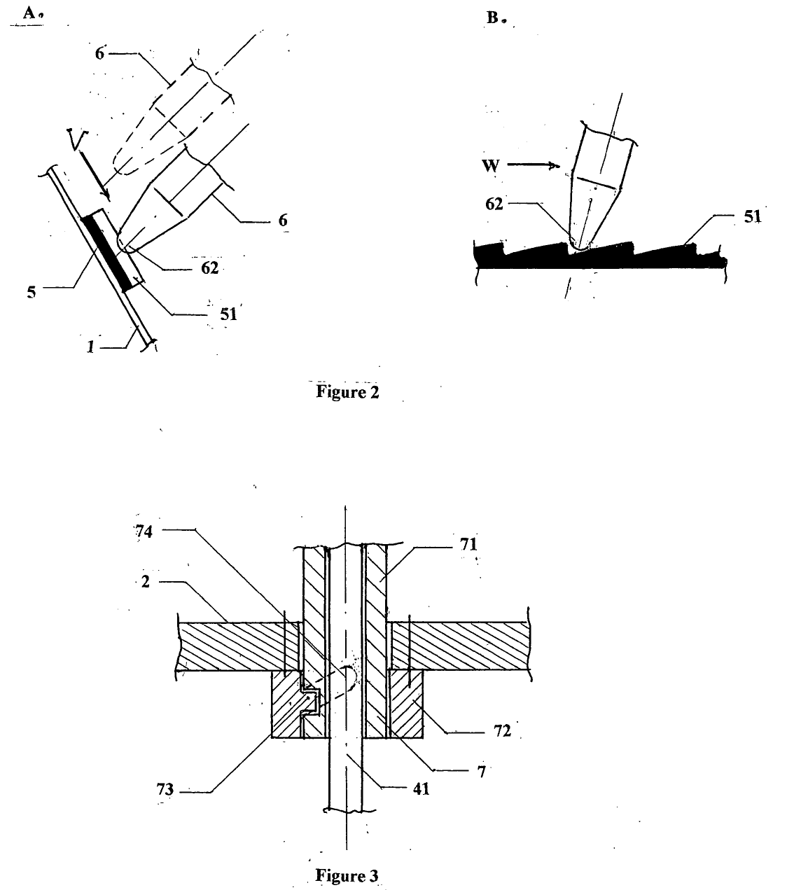

As is shown in FIGS. 1 and 2, striking means 5 is ring having a number of teeth 51 on its inner surface. The ring is affixed to any stationary support, for example, to housing 1, as is shown in FIG. 1. When rotor 2 with tubes 6, is in its lowest position (before the processing of tubes 6 starts), there is a gap between teeth 51 and tubes' tips 62. When the process starts, rotation of the tubes generates centrifuge force applied to the tubes to their tips 62. This force moves tips 62 toward teeth 52 in a position where striking means 5 engages the tips, and presses the tips against the teeth. As a result, the tips running over the teeth receive periodical strikes. At speed of rotation of the rotor, for example, 1500 rpm, which is usual for an electric motors, each tip receives tens of thousands strikes per minute. These strikes induce vigorous motion of the media inside the tubes. Due to this, mixing or resuspension of substances is performed almost instantly (in 5-7 sec.), and disintegration of cells, or disruption of tissues requires 2-3 min. To reduce noise caused due to striking of tubes 6, striking means 5 is made of elastic material, for example rubber, having high wearing resistance. As is shown in FIG. 1, striking means is inclined about axes of tubes 6. This inclination simplifies engagement and disengagement of the tubes with the striking means. Angle “C” (FIG. 1) characterizing interposition of the tubes and the striking means is less then 90 degree.

To enhance effectiveness of mixing of substances, the rotor includes removable closure 3 overlapping flanges 61 of tubes 6 and pressing gently the flanges against rotor 2 (FIG. 1). For this purpose closure 3 includes an elastic bottom 31 faced to the flanges, gently pressing them by the weight of the closure. Simultaneously the closure prevents fly out of tubes 6 from rotor 2. Removable plug 8 fixes working position of closure 3 on rotor 2.

Electric motor 42 of driving means 4 provides clockwise and counterclockwise rotation of shaft 41. For the mixing process the shaft is rotated in one direction and rotor 2 is moved downward, in its lowest position. In this position striking means 5 engages tubes 6. When the first stage of the process is finished, rotation of the shaft changes its direction to opposite and rotor 2 is moved upward. Simultaneously, striking means 5 disengages tubes 6 (FIG. 2).

Depending on operator's needs, filling of rotor 2 with tubes 6 can be made when rotor 6 is attached to driving means 4 of the device, or detached from the device. In the last case the rotor should be placed to a special stand on a laboratory bench. The stand may comprise: a base having a column and a plate affixed to the top end of column. Sleeve 71 of rotor can seat upon and embrace the column. In this position rotor can be used as a rack for filling the tubes or making other manipulations with the tubes. To facilitate manipulations with the tubes and recording of placed tubes, the rotor can be rotated on the stand along its vertical axis, and openings 22 are numbered.

This invention is not limited to the details shown since various modifications and structural changes are possible without departing in any way from the spirit of the present invention. What is desire to be protected is set forth in particular in the appended claims.

1. An automated device for processing media contained in test tubes, providing homogenization or resuspension of substances, or disruption of living cells, or disintegration of tissues, or centrifugation of these media by rotation the tubes about an axis/axes located outside said tubes, processing said media in said tubes in two consequent stages: the first is homogenization or resuspension of substances, or disruption of living cells, or disintegration of tissues, and the second is centrifugation the media.

2. A device according to claim 1, comprising:
(a) a rotor for said tubes, having separated spaces, accommodating one tube in one space;
(b) a means for changing position of said rotor along vertical axis of said rotor;
(c) a driving means for rotation of said rotor, including an electric motor having substantially vertical shaft capable to be rotated clockwise or counterclockwise at different speed;
(d) a striking means, capable to engage walls of said tubes and to strike periodically said tubes in this engaged position, capable to disengage the walls of said tubes.

3. A device according to claim 2, wherein each of said tubes placed in said separated spaces of said rotor is capable to change its angular position under the applied outer force.

4. A device according to claim 3, wherein said means for changing position of said rotor along its vertical axis includes a sleeve having at least one spiral groove at its outside wall and a bush moveable along said sleeve.

5. A device according to claim 4, wherein said bush includes at least one extension accommodated by said groove(s), moveable up and down inside the groove when said sleeve is rotated, fixing extreme upper and lower positions of said bush along said shaft.

6. A device according to claim 5, wherein said bush is attached to said rotor such that said rotor and said bush are moved as a single integrated part.

7. A device according to claim 6, wherein when said rotor is in its extreme lower position said striking means engages walls of said tubes placed in said rotor, and when said rotor is in its extreme upper position said striking means disengages said walls.

8. A device according to claim 7 wherein said rotor includes a removable closure having an elastic bottom engages flanges of said tubes placed in said rotor, presses the flanges against said rotor.

9. A device according to claim 4, wherein said rotor is integrated with said bush.

10. A device according to claim 2, wherein said rotor can be easy removed from said shaft and placed on a separate stand to be used as a tube rack.
